(19) United States
(12) Patent Application Publication
(10) Pub. No.: US 2002/0059418 A1
(43) Pub. Date: May 16, 2002

(54) Method of and system for recording and displaying electronic mail statistics

(76) Inventors: Alan Bird, San Diego, CA (US); Apul Nahata, San Diego, CA (US); Jeffrey K. Belk, Poway, CA (US); Paul E. Jacobs, La Jolla, CA (US)

Correspondence Address: QUALCOMM Incorporated, Attn: Patent Department, 5775 Morehouse Drive, San Diego, CA, 92121-1714, US

(21) Appl. No.: 09/907,150

(22) Filed: Jul. 16, 2001

Related U.S. Application Data
(60) Provisional application No. 60/218,774, filed on Jul. 17, 2000.

(51) Int. Cl. G06F 15/16

(52) U.S. Cl. 709/224; 709/206

(57) ABSTRACT

A method of and system for monitoring and displaying to a user a variety of email usage statistics provides a relatively simple user interface that provides entertaining and useful information that may affect the users' e-mail usage practices and habits.

### CROSS-REFERENCE TO RELATED APPLICATION

The present application claims the benefit of U.S. Provisional Application No. 60/218,774, filed Jul. 17, 2000, titled Method of and System for Recording and Displaying Electronic Mail Statistics.

### FIELD OF THE INVENTION

The present invention relates generally to the field of electronic mail (e-mail) software and systems, and more particularly to a method of and system for recording and displaying e-mail usage statistics.

### BACKGROUND OF THE INVENTION

Electronic mail (e-mail) has become a ubiquitous form of communication in recent years. In general, e-mail works as follows. E-mail software is installed on a client device, e.g., a personal computer (PC), equipped or configured for communications with a multiplicity of other client devices via a communications network. E-mail software, embodied in the e-mail client, enables a user of the client device to compose e-mail messages, send e-mail messages to other client devices, and read e-mail messages received from other client devices. The typical e-mail client supports various e-mail protocols, such as Post Office Protocol Version 3 (POP3), Simple Mail Transfer Protocol (SMTP), Internet Mail Access Protocol Version 4 (IMAP 4), or Multipurpose Internet Mail Extensions (MIME).

E-mail has become a predominant form of intra-organizational communication. In many business organizations, each member of the organization has a computer with a network connection on his or her desk. Most members of an organization have continuous and immediate access to e-mail. Members of an organization can write, send, receive, reply to, and forward e-mail messages quickly and easily. A member of an organization may process tens or even hundreds of e-mail messages over the course of a day or week.

A consequence of the proliferation of e-mail in the business environment is that individuals may perceive they are spending a large part of their working time processing a tremendous volume of e-mail. Currently, however, there is no system for keeping track automatically of the individuals e-mail usage. Certain individuals may take pride in announcing to their co-workers how much e-mail they process. However, their statements as to the volume of e-mail they process are based upon perceptions and not upon real data.

### SUMMARY OF THE INVENTION

The present invention provides a method of and system for monitoring and displaying to a user a variety of e-mail usage statistics. The present invention provides a relatively simple user interface that provides entertaining and useful information that may affect the users' e-mail usage practices and habits.

### BRIEF DESCRIPTION OF THE DRAWINGS

FIG. 1 is a high-level block diagram of an e-mail system.

FIG. 2 is a pictorial view of a statistics selection menu according to the present invention.

FIG. 3 is a pictorial view of a statistics window illustrating a period selection menu and received mail statistics according to the present invention.

FIG. 4 is a pictorial view of a statistics window illustrating sent mail statistics according to the present invention.

FIG. 5 is a pictorial view of a statistics window illustrating usage statistics according to the present invention.

### DESCRIPTION OF THE PREFERRED EMBODIMENT

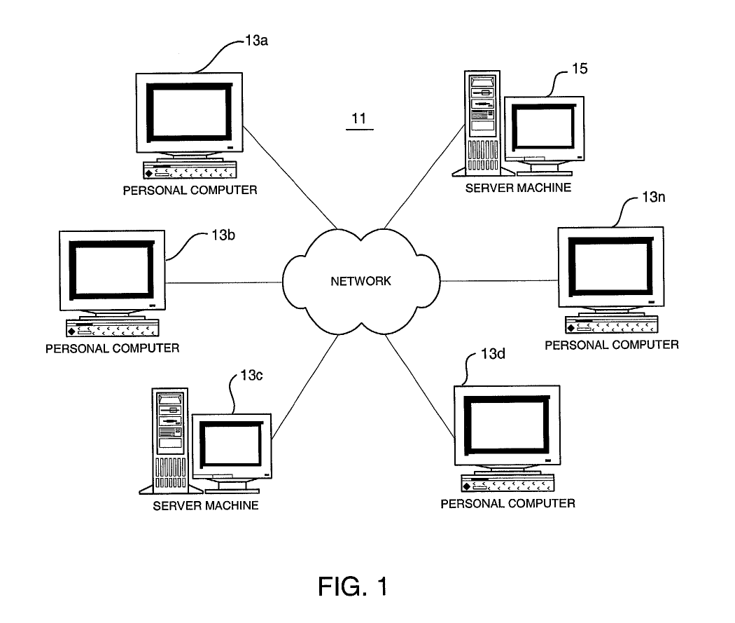

Referring now to the drawings, and first to FIG. 1, an electronic mail (e-mail) system is designated generally by the numeral 11. System 11 includes a plurality of client machines 13, which are preferably implemented in personal computers, and at least one server machine 15. The personal computer client machines 13 have installed thereon client software according to the present invention that operates preferably in a graphical operating environment, such as Windows 98. Client machines 13 and server machines 15 are interfaced to a network indicated generally at 17. Network 17 may be a local area network, a wide area network, the Internet, or a combination of such networks. Client machines 13 and server machines 15 may be interfaced to network 17 through network interface cards, internet service providers, or the like, as is well known to those skilled in the art.

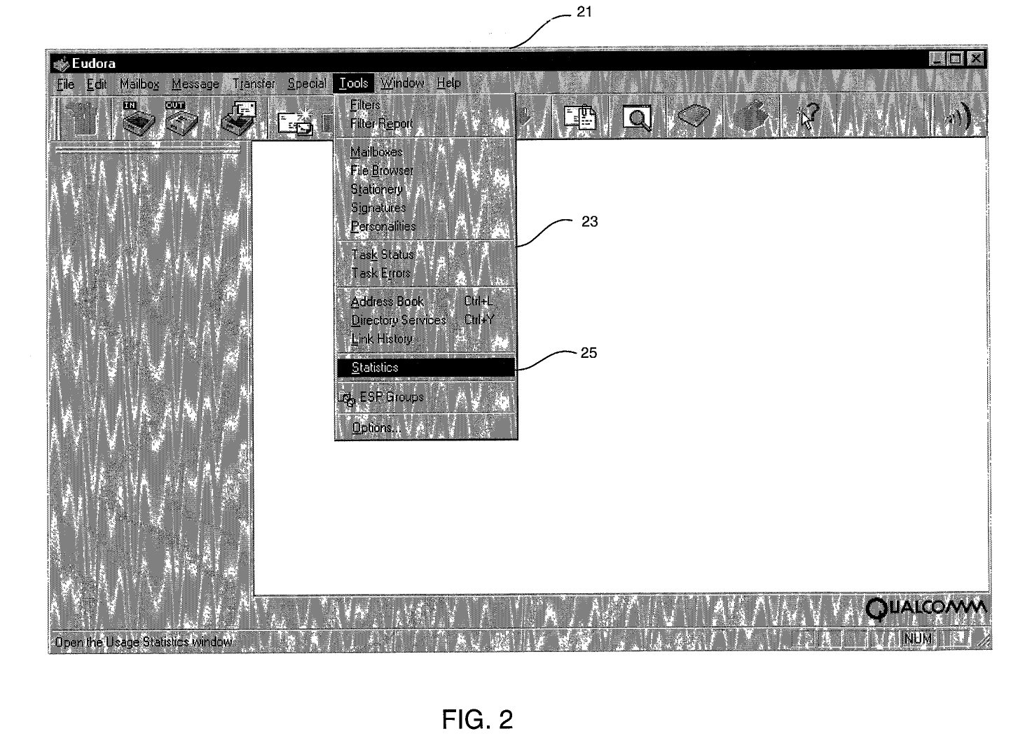

According to the present invention, various e-mail usage statistics are collected and stored, preferably locally in a database on an individual e-mail client. Statistics are accessible by and displayed to a user through windows of the type illustrated in FIGS. 2-5. Preferably, the user interface of the present invention provides a statement of statistics since a particular date, which in the preferred embodiment is the date that the email client was installed.

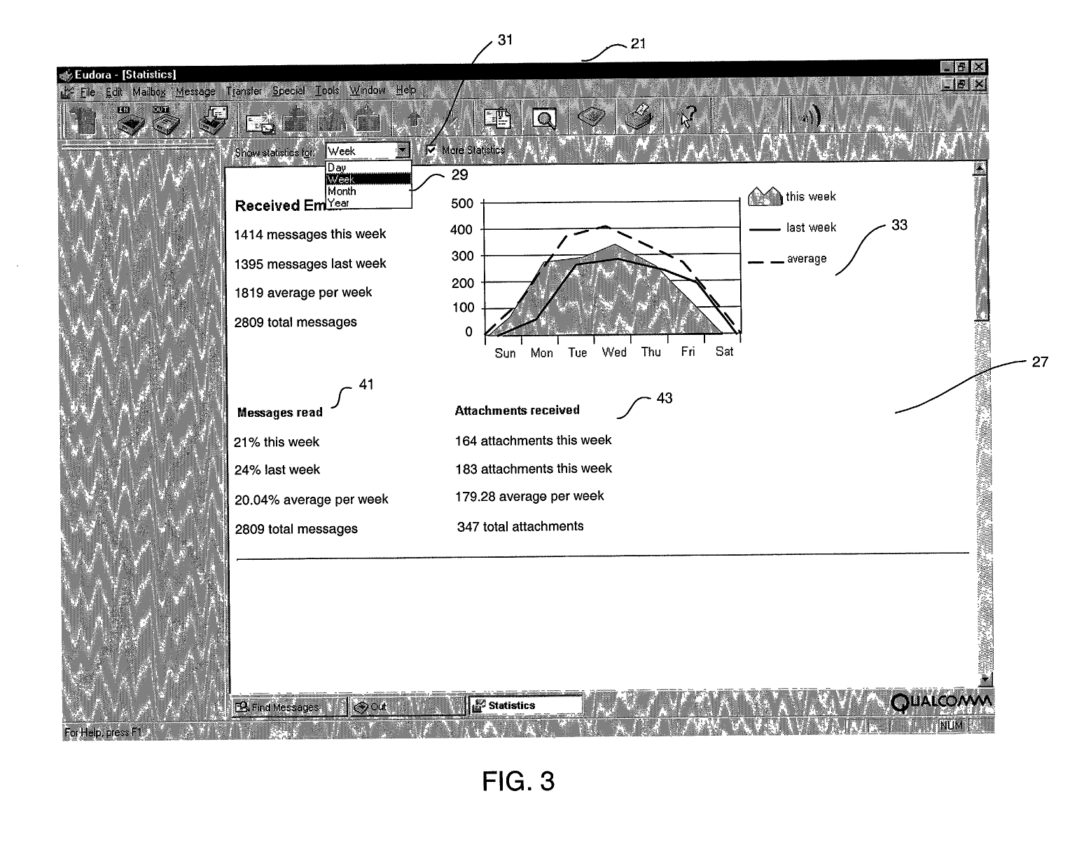

Referring to FIG. 2, an electronic mail application window is designated generally by the numeral 21. Under a tools group there is a drop down menu 23 that includes a statistics choice 25. Selection of statistics choice 25 causes the system to display a statistics window 27, as illustrated in FIGS. 3-5.

Referring to FIGS. 3-5, the user interface of the present invention includes a pull-down menu 29 to control the date range to be selected. Date range options may include, day, week, month and year. Typically, a date starts at midnight and a week starts on Sunday.

As illustrated in FIGS. 3-5, statistics may be shown with a comparison of current, recent and averaged data. For example, in FIGS. 3-5 in which the week duration is chosen, the statistics for the current week, the last week and the average of all weeks may be shown. The information may be shown numerically and/or graphically.

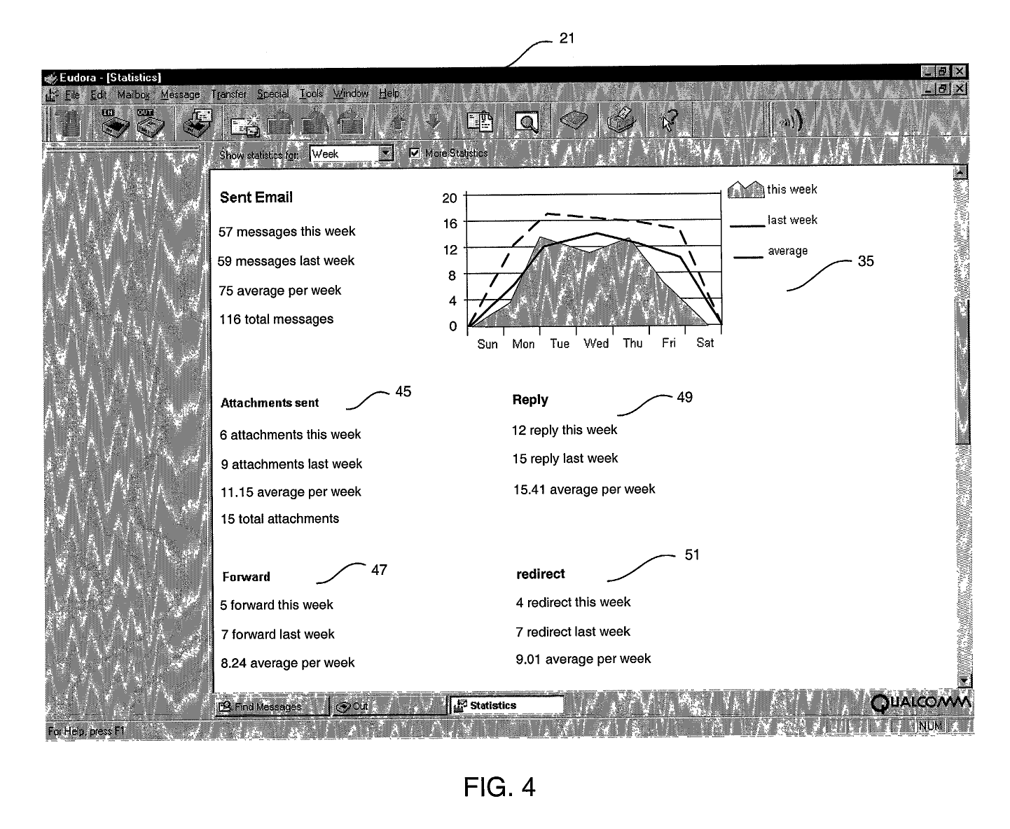

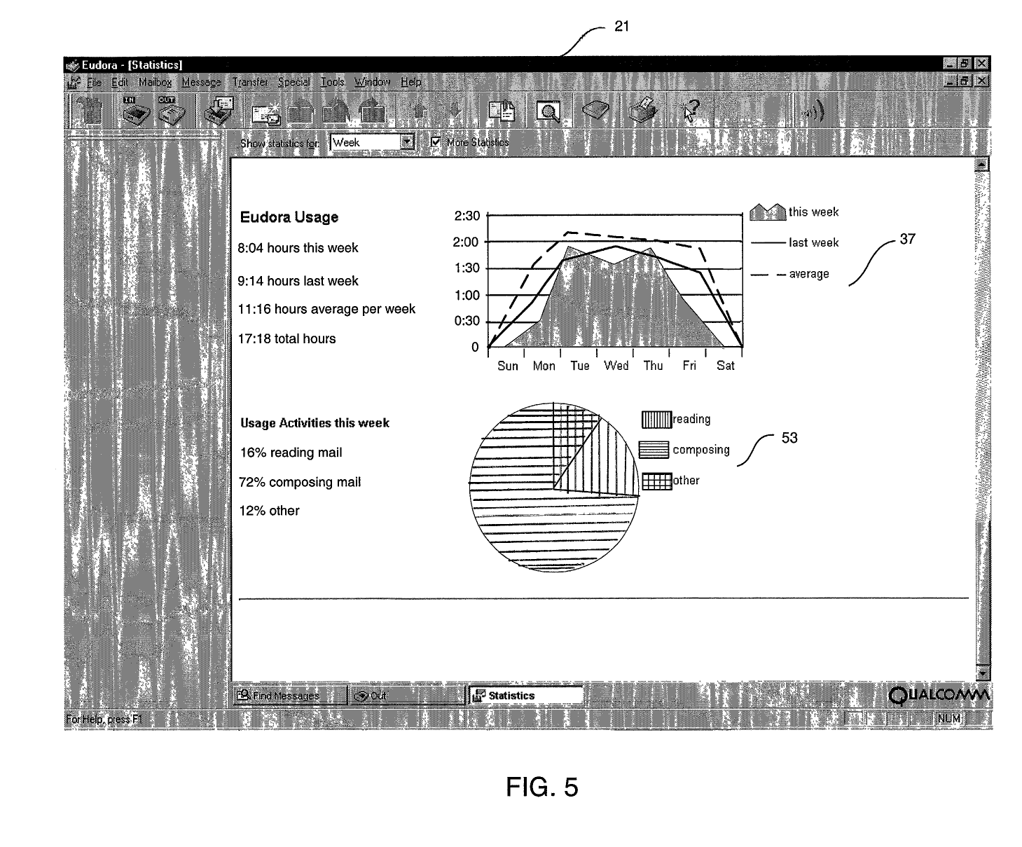

Information may be classified into groups including received email statistics (FIG. 3), sent email statistics (FIG. 4), and usage statistics (FIG. 5). Usage statistics include time spent actually doing various e-mail operations. Additional information, such as e-mail features statistics, may be shown according to the present invention.

In the preferred embodiment, the system of the present invention provides a basic statistics view and additional statistics views, which is illustrated in FIGS. 3-5. A more statistics check box 31 is provided so that a user can select either the basic statistics view or the additional statistics view. The basic statistics view includes basic received email statistics 33, basic sent email statistics 35, and basic usage statistics 37.

As shown in FIG. 3, basic received email statistics view 33 includes a display of received email activity, including a graph showing current, recent, and average number of emails received. The total email counts for current, recent and average periods may also be shown in text form. As shown in FIG. 4, the basic sent email statistics view 35 shows all mail sent since the installation of the e-mail client, as well as recent sent mail activity. The sent mail activity provides a graph showing current, recent, and average number of e-mails, with the total e-email counts for current, recent and average periods also shown in text form. As shown in FIG. 5, the basic e-mail usage statistics view 37 provides a graph depicting current, recent, and average usage time. Total usage time for the current, recent and average periods may also be shown in text form.

According to the present invention, more detailed statistics may be displayed by checking box 31. Examples of more detailed information are illustrated in FIGS. 3-5.

As shown in FIG. 3, the received email group may include statistics with respect to messages read, as indicated at 41, and attachments received, as indicated at 43. The received email group may also display statistics of received messages that have been opened versus those that have not been opened. The received email group may also provide statistics of received messages that have been deleted and those that have been deleted without ever having been opened. The received email group may also provide statistics as to the most frequent incoming message senders. The received email group may also provide statistics as to the most frequent senders of messages of a particular type. Those skilled in the art will recognize other statistics that may be kept and displayed according to the present invention.

Referring now to FIG. 4, the more detail view with respect to sent email preferably includes a display of statistics with respect to attachments sent, as indicated at 45, as well as the forwarding, replying to, and redirecting of received mail, as indicated at 47-51, respectively. In the illustrated example, this information is displayed numerically in tabular form with counts for the various activities for the current, recent and average time periods. The information may also be displayed in graphical form.

The system of the present invention may provide additional statistics with respect to attachments. For example, the system may provide information as to the average size of sent or received attachments. The system may also identify the most frequent senders or recipients of attachments.

The system may provide, in addition to the basic and more detailed information described above, statistics with respect to sent mail forwarding, replying, and redirecting. The system may identify a selected number of most frequent message senders or recipients, or senders or recipients of messages of a particular type.

As shown in FIG. 5, the more detailed usage view generally provides statistics as to the amount of time spent in message composition, message reading and other application tasks, as indicated at 53. In FIG. 5, the usage group provides a pie chart depicting reading time, composing time, and other time for current activity. Percentages or actual clock time information may be shown in a textual format.

In addition to information with respect to received and sent email and usage described above, the system of the present invention may provide information, preferably in table format, with respect to the use of various features of the e-mail application. For example, the features group may provide information as to the most or least frequently used toolbar buttons, filters, mail boxes, signatures, stationery, or other features of the mail application.

From the foregoing, it may be seen that the present invention provides useful and interesting information to e-mail users. The user can use the information made available by the present invention to spot inefficiencies in his or her work habits. The information may also be of use to developers in providing better or more useful versions of e-mail products.

Those skilled in the art will recognize that the specific statistics and modes of display are illustrative only and that other statistics may be displayed. For example, such information as average time spent viewing open messages or composing messages may be displayed.

What is claimed is:

1. A method of providing electronic mail information to a user, which comprises:
collecting data for a each of plurality electronic mail activities for a user; and,
displaying selected information with respect to said electronic mail activities.

2. The method as claimed in claim 1, wherein said information is displayed according to a user selected time period.

3. The method as claimed in claim 2, wherein said user selected time period is one day.

4. The method as claimed in claim 2, wherein said user selected time period is one week.

5. The method as claimed in claim 2, wherein said user selected time period is one month.

6. The method as claimed in claim 2, wherein said user selected time period is one year.

7. The method as claimed in claim 2, wherein said information is displayed for a current time period and a prior time period.

8. The method as claimed in claim 2, wherein said information is displayed as an average over said selected time period.

9. The method as claimed in claim 1, wherein said information includes basic information and, in response to user selection, additional information.

10. The method as claimed in claim 1, wherein said information includes information with respect to electronic mail items received during a current selected time period.

11. The method as claimed in claim 10, wherein said information includes information with respect to electronic mail items received during a prior selected time period.

12. The method as claimed in claim 10, wherein said information includes average number of electronic mail items received per said selected time period.

13. The method as claimed in claim 1, wherein said information includes information with respect to electronic mail items sent during a current selected time period.

14. The method as claimed in claim 13, wherein said information includes information with respect to electronic mail items sent during a prior selected time period.

15. The method as claimed in claim 13, wherein said information includes average number of electronic mail items sent per said selected time period.

16. The method as claimed in claim 1, wherein said information includes information with respect to time spent using electronic mail during a current selected time period.

17. The method as claimed in claim 16, wherein said information includes information with respect to time spent using electronic mail during a prior selected time period.

18. The method as claimed in claim 16, wherein said information includes average time spent using electronic mail per said selected time period.

19. The method as claimed in claim 1, wherein said information is displayed in graphical form.

20. The method as claimed in claim 1, wherein said information is displayed in numerical form.

21. A system for providing electronic mail information to a user, which comprises:
a database for storing data for a each of plurality electronic mail activities for a user; and,
a display configured to present selected information with respect to said electronic mail activities.

22. The system as claimed in claim 21, a control for enabling said user to display information according to a user selected time period.

23. The system as claimed in claim 22, wherein said user selected time period is one day.

24. The system as claimed in claim 22, wherein said user selected time period is one week.

25. The system as claimed in claim 22, wherein said user selected time period is one month.

26. The system as claimed in claim 22, wherein said user selected time period is one year.

27. The system as claimed in claim 22, wherein said information is displayed for a current time period and a prior time period.

28. The system as claimed in claim 22, wherein said information is displayed as an average over said selected time period.

29. The system as claimed in claim 21, wherein said information includes basic information, and said system includes a control for enabling said user to display additional information.

30. The system as claimed in claim 21, wherein said information includes information with respect to electronic mail items received during a current selected time period.

31. The system as claimed in claim 30, wherein said information includes information with respect to electronic mail items received during a prior selected time period.

32. The system as claimed in claim 30, wherein said information includes average number of electronic mail items received per said selected time period.

33. The system as claimed in claim 21, wherein said information includes information with respect to electronic mail items sent during a current selected time period.

34. The system as claimed in claim 33, wherein said information includes information with respect to electronic mail items sent during a prior selected time period.

35. The system as claimed in claim 33, wherein said information includes average number of electronic mail items sent per said selected time period.

36. The system as claimed in claim 21, wherein said information includes information with respect to time spent using electronic mail during a current selected time period.

37. The system as claimed in claim 36, wherein said information includes information with respect to time spent using electronic mail during a prior selected time period.

38. The system as claimed in claim 36, wherein said information includes average time spent using electronic mail per said selected time period.

39. The system as claimed in claim 21, wherein said information is displayed in graphical form.

40. The system as claimed in claim 21, wherein said information is displayed in numerical form.
